(19) United States
(12) Patent Application Publication
(10) Pub. No.: US 2002/0033222 A1
(43) Pub. Date: Mar. 21, 2002

(54) Method and an apparatus for producing filamentous textile structures

(75) Inventors: Peter Anderegg, Winterthur (CH); Christian Griesshammer, Winterthur (CH)

Correspondence Address: STEPHEN E. BONDURA, ESQ, DORITY & MANNING, P.A., P.O. BOX 1449, GREENVILLE, SC, 29602-1449, US

(73) Assignee: Maschinefabrik Rieter AG

(21) Appl. No.: 09/911,074

(22) Filed: Jul. 23, 2001

(30) Foreign Application Priority Data
Jul. 26, 2000 (CH) 1478/00

(51) Int. Cl. B31C 1/00

(52) U.S. Cl. 156/174; 156/271; 156/62.2

(57) ABSTRACT

Filamentous textile structures are produced from a quasi continuous planar nonwoven (1) by subjecting the nonwoven (1) to fluid-dynamic forces, namely in such a way that the nonwoven (1) is split up longitudinally into a plurality of parallel slivers (3) and the fiber structure of the nonwoven (1) is bonded in the slivers. For the treatment with fluid-dynamic forces, the nonwoven (1) is placed for example against a treatment template (10) which is structured in a strip-like manner by perforations (11) and elevations (12) and fine water, saturated steam or air jets (13) are directed against the nonwoven (1) and the template (10). The slivers produced during the treatment with the fluid-dynamic forces can be processed without any further treatment into a planar textile structures or they can be subjected to a further treatment prior to said processing in order to increase their strength. Said further treatment can preferably be performed without any application of additives (false twist, rubbing) or it is a further treatment which can be reversed after the production of the planar structure (treatment with glue). The slivers (3) have a relatively large volume and can therefore be weaved into covering fabrics with relatively low thread densities. They are suitable for example as weft yarns in fabrics for low-quality needs such as fabrics for disposable linens.

The invention lies in the field of textile technology and relates to a method and an apparatus according to the preambles of the respective independent claims. The method and the apparatus relate to the production of filamentous textile structures made of staple fiber material.

Staple fiber materials such as cotton or wool consist of fibers of limited length. In order to produce filamentous structures from such materials the fibers are usually processed by carding machines into a plane card web which is then joined into a card sliver. In the card sliver the fibers are no longer random, but preferably aligned in the processing direction. The card sliver is then converted by drafting and further alignment of the fibers into a longitudinal structure in which the fibers lie closer with respect to one another than in the card web and are parallelized to an even higher extent. Said longitudinal structure is processed into a thread by twisting (spinning), in which thread the fibers are connected merely by mutual friction and which thread is provided with a considerable resistance to tearing by said friction. Such threads are further processed by weaving, knitting or other methods as are known in the textile industry.

One advantage of the aforementioned process, which leads from a loose fiber structure as is represented by the card web to a planar structure with a high strength, is that no additional materials are required for this purpose, meaning that high-quality planar structures can be produced thereby which substantially only consist of the fibers of the starting material. For the aforementioned processes the fibers to be processed must have a minimal length. Accordingly, a part of the fibers will optionally be incurred as waste from a natural fiber material which contains short and very short fibers. The threads produced according to the said process are very compact, so that in the planar structures produced therefrom they must be disposed very close to one another (high thread density) if the planar structure is to be covering.

Lesser compact threads which contain the same quantity of fiber material would have a larger volume than the aforementioned spun threads and could still form a covering woven at a lower thread density. For this reason efforts are made especially for the production of cheap planar textile structures to increase the thread volume, e.g. by using a loose fiber structure, by holding the fibers together with further means in addition to the mutual friction or by connecting a conventionally spun thread with a loose fiber structure. The fibers in these looser fiber structures are held together with adhesives for example which allow keeping short and very short fibers within the structure. It is also known that from planar structures which are produced from such filamentous structures the adhesive can be extracted again at least in part. This is possible because a filamentous structure needs to have a considerably higher strength (better mutual adherence of the fibers) for the further processing into a planar structure than is the case in the produced planar structure where threads which are in mutual contact further stabilize one another. In the following sections a number of known methods are listed with which it is tried by using fiber structures which are looser than the fiber structures in spun threads to still produce with less fiber material planar structures which offer satisfactory strength and cover to the highest possible extent.

In the patent specification U.S. Pat. No. 5,622,766 or EP-0629723 it is proposed for example to increase the volume of conventional threads by associating each of them with a longitudinal strip of a card web. A number of parallel extending threads is combined with a card web and treated with the help of a suitable adhesive. Thereafter the card web, whose fibers are also glued to one another by the treatment with glue, is cut with the threads adhering thereto into a longitudinal structure between two threads each. Said longitudinal structures which comprise a thread each with a strip of the web adhering thereto can be used after a respective conditioning as weft thread for weaving a planar structure. The conditioning is not specified in the publication. The glue is removed after the weaving from the planar structure. It has been seen that in this way a covering woven can be produced which has up to six times fewer weft threads per unit of length than a woven which is weaved with the same untreated threads without any additional loose fiber structure. A woven thus produced is very absorbent due to the loose arrangement of the fibers originating from the nonwoven and is also not capable of withstanding any excessive mechanical load.

A similar method is also described in the publication DE-1660214. According to this method multifilament threads are produced whose volume is increased by the addition of a loose fiber structure. The threads consist of thermoplastic filaments and are brought into connection with the loose fiber structure in the not yet fully cooled state, which occurs in such a way that the fibers come to adhere more or less permanently on the threads. In accordance with the publication FR-515357 an assemblage of still adhesive, thermoplastic fibrils is also brought together with a planar loose fiber structure which is thereafter cut into strips. Both methods are not applicable for the production of planar textile structures which should consist only of natural fibers for example.

Further methods for enlarging the volume of threads or yarns joining spun threads for example by adding loose fibers (flocking) are described in the publications EP-0339965, U.S. Pat. No. 3,835,638 or JP-2289137. In all cases a gluing effect for the connection between threads and loose fibers is used.

Methods according to which planar textile structures are produced from fiber directly, i.e. without the production of filamentous structures, usually consist of arranging the fibers in a planar manner, of compressing the nonwoven thus produced and to entangle (i.e. to needle or tangle) the fibers in the compressed structure with one another in such a way as many fiber contact places occur for an internal friction which can provide the planar structure with the desired strength. Mechanical means are used for the entanglement in a planar fiber structure such as needles or recently also fluid-dynamic means such as water, saturated steam or air jets.

With the help of such fluid-dynamic methods it is not only possible to entangle the fibers which are present in a predominantly disordered manner in a pressed nonwoven, it is simultaneously also possible to arrange them in a predetermined planar structure. It is described in the publications U.S. Pat. No. 3,768,121 and CH-619581 how a structured planar structure is produced from a substantially disordered nonwoven by the influence of purposeful fluid-dynamic forces which is suitable for disposable cloths for example. The structure consists of low-fiber zones or openings which alternate with zones of higher fiber density in which the fibers are also aligned parallel to a higher degree than in the original nonwoven. This structuring is achieved by positioning the nonwoven between perforated templates and by directing fluid jets through the templates and the interposed nonwoven. It was noticed that the elevations in the templates against which the fibers are pressed by the air or water jets lead to low-fiber zones and the fibers displaced from such low-fiber zones will become arranged in a more or less mutually aligned manner about the low-fiber zones. It is proposed in the publications to produce planar structures with such methods in which the low-fiber zones extend in a crisscross manner and alternate with low-fiber zones, which therefore have a structure which is at least similar to a woven structure.

The invention has the object of providing a method with which filamentous textile structures can be produced from a staple fiber material which are suitable without any further processing for the production of planar textile structures according to methods known per se in the textile industry. The filamentous structures are to be provided with a high volume, namely in such a way that they can still be processed into covering planar structures with relatively low thread densities. The filamentous structures are to be stable even without the addition of permanent bonding agents, namely in such a way that planar structures can be produced therefrom which consist only of natural staple fibers for example and still come with sufficient strength necessary for an intended application. It should further be possible to integrate even the shortest possible fibers and fiber parts in the filamentous structures. It is also the object of the invention to provide an apparatus to perform the method for producing the filamentous structures.

These objects are achieved by the method and the apparatus as are defined in the claims.

The method in accordance with the invention is based on staple fiber material which is present in form of a planar and quasi continuous nonwoven which is produced in the known manner, e.g. a card or carded web. Preferably, the fibers in this nonwoven are already aligned to a higher extent in the longitudinal direction of the quasi continuous nonwoven, as is the case in a card or carded web. The quasi continuous nonwoven is broken down into a plurality of card slivers and the fiber structure is bonded, with respectively controlled fluid-dynamic forces being used for the breakdown and/or for at least a part of the bonding. Any further bonding, if necessary, is performed with methods known per se.

A particularly simple and thus especially advantageous method is obtained when the fluid-dynamic forces utilized for the production of the card slivers from the nonwoven are controlled and optionally supplemented with additional mechanical forces in such a way that the nonwoven is split into card sliver by said forces and the fiber structure is bonded substantially simultaneously in the produced card slivers by entangling. It has been seen that card slivers produced in such a way can achieve a strength which is sufficient for the strength of a planar structure. In order to further increase the strength of the card slivers, especially for the production of the planar structure, they can be subjected to a further treatment (e.g. with bonding agents or by false twisting), with said treatment preferably being reversed at least partly again after the production of the planar structure. Spinning of the card slivers is not recommended as further treatment, because in this way the volume of the card slivers is reduced too strongly. It has further been seen that even very short fibers are well stabilized in such a card sliver.

On the other hand, it is also possible to split up the nonwoven into slivers with other means than fluid-dynamic forces, e.g. to use mechanical separating means and fluid-dynamic forces for their bonding only. It is also possible to use the fluid-dynamic means substantially only for splitting up the nonwoven into the slivers and to realize the bonding with the same methods as are described for the further treatment.

The method in accordance with the invention for the production of filamentous textile structures can be performed, as is explained in the above brief description, very easily and in a single continuous process particularly in the application of fluid-dynamic forces for splitting up the nonwoven into slivers and for the bonding of the fiber structure or partial bonding of the fiber structure.

The slivers produced according to the method in accordance with the invention can be processed especially without any substantially drafting and spinning and also without any joining with any further filamentous structure into planar structures according to methods as known per se in the textile industry, whereby they also need not be subjected to any specific conditioning for specific processing. The bonded slivers which are produced according to the method in accordance with the invention are preferably wound up on bobbins and are processed from the bobbins into planar structures, e.g. by weaving and knitting. Mixed fabrics can also be produced, with a spun yarn being used as warp thread and slivers produced according to the inventive method being used as weft threads.

Planar structures such as woven textiles which consist at least partly of the slivers produced according to the method in accordance with the invention have a similar appearance as respective structures from spun yarns, but already show no visible gaps at a considerably smaller thread density, which means they are covering. The planar structures show a small quantity of fibers per surface unit. Due to the low thread density they can be produced at high process speeds and can contain a considerable share of short and therefore low-quality fiber material. All these properties make planar structures which contain slivers produced according to the inventive method very cheap as compared with respective structures made of spun threads or even of spun threads and ones flocked in any manner whatsoever. It is understood that they are not so hard-wearing as respective woven textiles made of spun fiber material.

For the above reasons, planar structures which are produced according to the inventive method such as woven textiles are particularly suitable for low requirements such as material for disposable linen or cleaning cloths. In the area of disposable linen (table or bed clothing) they can easily compete with respective “nonwoven” products. As a result of the fact that they are woven they come with the advantage of looking more like traditional linen and feeling more like the same.

The apparatus in accordance with the invention with which the slivers are produced is equipped for producing and controlling fluid-dynamic forces and for positioning the quasi continuous nonwoven, which has optionally already been split into a plurality of slivers by other means, in the zone of said forces, with the two functions being adjusted to one another and to the nonwoven to be processed that the positioned nonwoven is split by the fluid-dynamic forces into a plurality of bonded slivers and/or the nonwoven is bonded. The apparatus in accordance with the invention is preferably provided in a treatment zone with a perforated treatment template which is structured in a strip-like manner and means for the production of fluid jets (e.g. air, saturated steam or water jets) directed against the treatment template and means for sucking off the fluid from the other side of the treatment template. Preferably, the apparatus is equipped in such a way that the nonwoven can be guided through the treatment zone, whereby it rests on the processing template or a supporting screen disposed between the template and the nonwoven. Optionally, the arrangement of the fluid jets and/or the structuring of the processing template is such that its effect changes between the entrance to the processing zone and the exit from the processing zone.

The apparatus is further provided with means for the preferably continuous supply of the nonwoven to and through the treatment zone and means for a respective path conveyance of the bonded slivers from the treatment zone. Optionally, there are also means for winding up the completed slivers (e.g. a yarn beam and/or a plurality of winding apparatuses).

In addition to the processing zone in which the nonwoven or the slivers are subjected to the fluid-dynamic forces, the apparatus can be provided with means for splitting up the nonwoven into slivers and means for further treating the slivers, e.g. a means for treating the slivers with a glue which can be removed from the fibers again after the production of the planar structure, or a means for the known temporary twisting (false twisting) of slivers. Such a means for further treatment must be disposed downstream from the treatment zone in which the nowoven is subjected to the fluid-dynamic forces.

Embodiments of the method and apparatus in accordance with the invention are described below in detail with reference to the following figures, wherein:

FIG. 1 shows the conversion of a nonwoven into slivers according to the preferred embodiment of the method in accordance with the invention;

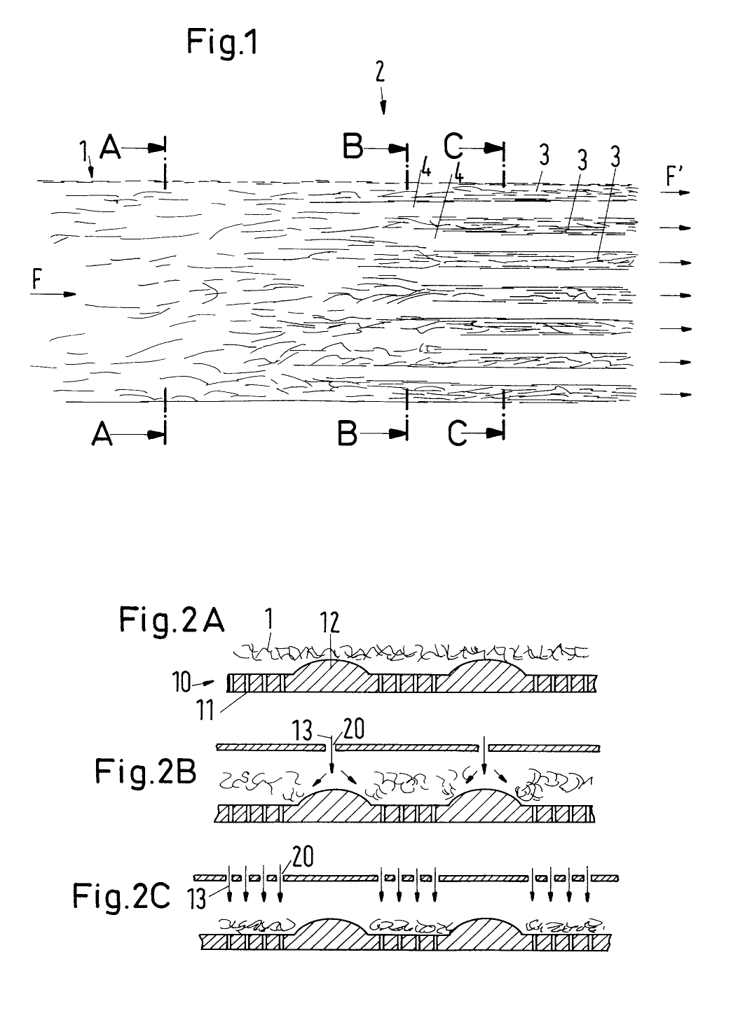

FIGS. 2a to 2c show sectional views through a nonwoven and slivers produced therefrom during the treatment with fluid-dynamic forces (lines of intersection A-A, B-B, C-C in FIG. 1);

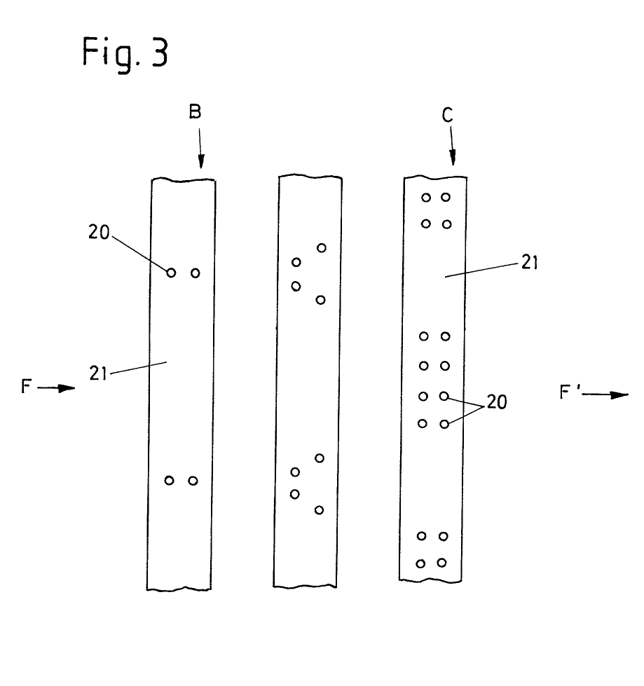

FIG. 3 shows a nozzle arrangement in form of an example to produce fluid jets for performing the method according to FIGS. 2a to 2c;

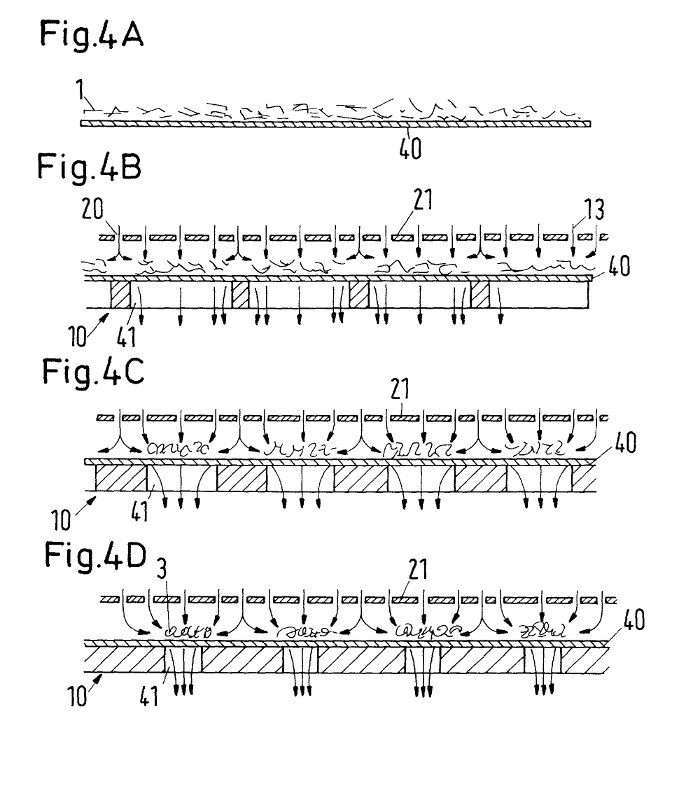

FIGS. 4a to 4d show four sectional views through the nonwoven and slivers to illustrate a further embodiment of the method in accordance with the invention;

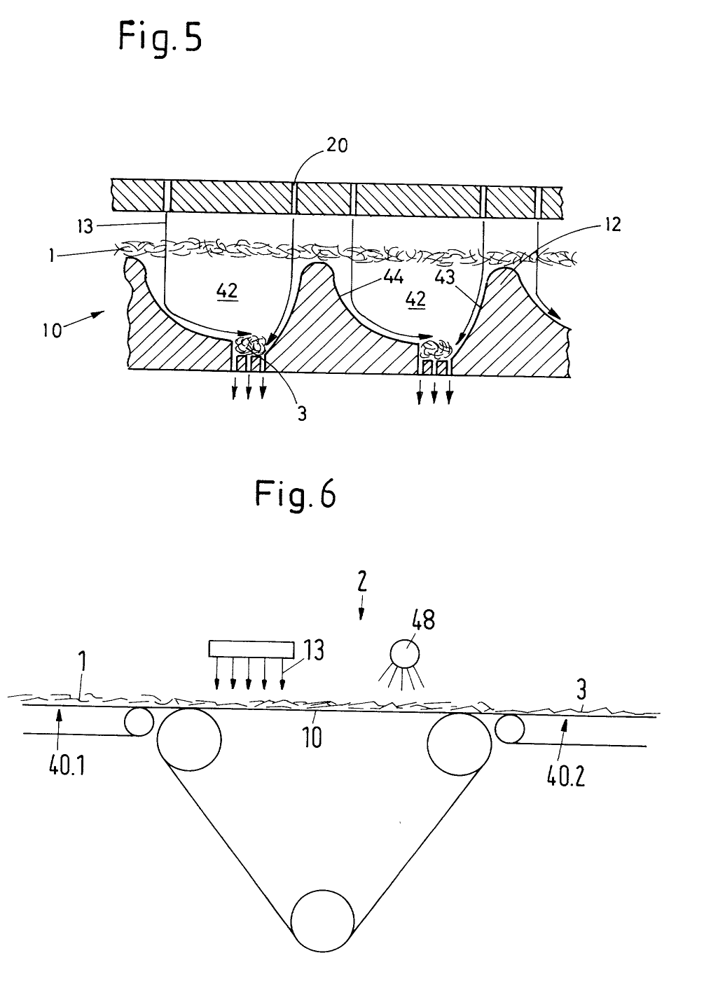

FIG. 5 shows a sectional view of a further treatment template 10 (sectional view as in FIGS. 2a to 2c) with a strip-like structuring and perforation;

FIG. 6 shows a schematic embodiment of the apparatus in accordance with the invention as an example;

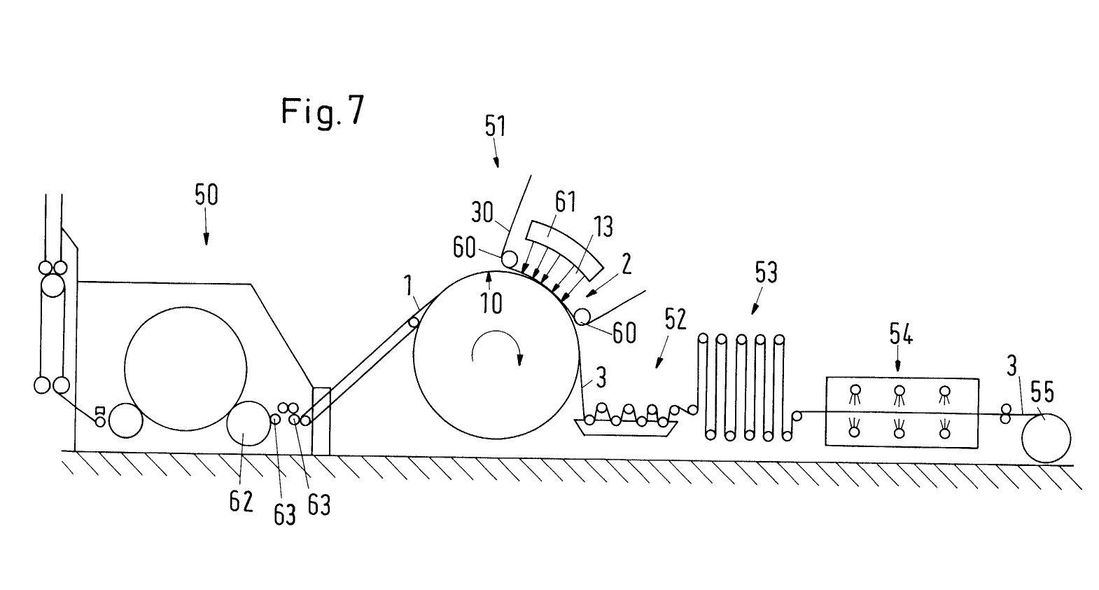

FIG. 7 shows a further schematically shown embodiment of the apparatus in accordance with the invention.

FIG. 1 illustrates a preferred embodiment of the method in accordance with the invention for producing filamentous textile structures from a staple fiber material, which filamentous textile structures are suitable for the production of planar textile structures according to methods known in the textile industry for processing spun threads for example.

A quasi continuous nonwoven 1 is conveyed in a conveying direction F towards a treatment zone 2 and through said treatment zone 2. During the conveyance through said treatment zone 2 a processing template is positioned on the one side of the nonwoven 1 and fine fluid jets such as water, saturated steam or air jets hit the nonwoven 1 from the other side (fluid jets and treatment template are not shown in FIG. 1). As a result of the fluid jets and processing template, strip-like low-fiber zones 4 and, alternating with the same, a plurality of parallel extending slivers 3 are obtained in the nonwoven in the conveying direction F. After the treatment position 2 the slivers 3 are conveyed away in a discharge direction F′. The fiber structure in the slivers 3 is condensed and bonded as compared with the fiber structure of the nonwoven 1, which means that the fibers are closer together in the slivers and are aligned to the major part in the conveying direction and are more entangled or twisted.

FIGS. 2a to 2c show sectional views (according to the lines of intersection A-A, B-B, C-C in FIG. 1) through the nonwoven 1 and through the slivers 3 produced therefrom during a kind of treatment with the treatment template shown as an example.

FIG. 2a shows the nonwoven 1 which is positioned on a treatment template 10. The treatment template 10 is structured by perforations 11 and elevations 12 in a strip-like manner in the conveying direction, with the elevations 12 extending, as is shown, in the conveying direction and the perforations 11 being disposed in the valleys situated between the elevations 12. In a first phase of the treatment (FIG. 2b) the fluid jets 13 (produced by nozzles 20) are directed against the elevations and displace the fibers positioned above the elevations 12 into the valleys between the elevations 12 and also provide them with a preferred alignment in the conveying direction F. In a second phase of the treatment (FIG. 2c) the fluid jets 13 are directed against the valleys provided with perforations 11 between the elevations 12, as a result of which the fibers which are positioned in said valleys are pressed against one another and are entangled by the effect of the needles.

In all parts of the processing region the fluid is sucked off from below the treatment template 10.

It has been noticed that with an arrangement of the treatment template 10 as represented in the figs. 1a to 2c it is possible to achieve favorable results also with fluid jets which are evenly distributed over the width of the nonwoven and whose arrangement remains the same from the entrance to the processing area up to its output.

FIG. 3 shows a top view of an arrangement of nozzles 20 for producing water, saturated steam or air jets in a treatment zone as is illustrated by the FIGS. 2a to 2c. The nozzles 20 are arranged for example as respective openings in a nozzle plate 21 or as individual nozzles. The nozzles 20 in a zone B (FIG. 2b, initial phase of treatment) are disposed in rows directed against the elevations 12 of the treatment template 10. Towards the zone C (FIG. 2c, end phase of treatment) the rows shift towards the valleys disposed between the elevations 12. In the zone C the nozzles 20 are directed against the valleys.

As already mentioned in connection with FIGS. 2a to 2c, favorable results are also achieved when the nozzles are evenly distributed over all nozzle beams 21.

For the treatment of the nonwoven 1 it is necessary to use very fine fluid jets, meaning that the nozzles have a diameter in the magnitude of 0.01 to 1.0 mm.

FIGS. 4a to 4d substantially show in the same manner as in FIGS. 2a to 2c a further treatment of a nonwoven 1 with fluid-dynamic forces as an example. In contrast to the fluid treatments as described further above, the nonwoven 1 or the slivers 3 rest on a supporting screen 40. The supporting screen 40 is provided with a regular perforation for example. In the processing zone, a stationary treatment template 10 is provided which comprises a strip-like pattern of slots 41. The slots 41 become narrower from the entrance of the treatment zone (5B) towards the exit of the treatment zone (5D). The fluid jets 13 are produced by an arrangement of substantially evenly distributed nozzles 20. As a result of the arrangement of the nozzles 20 and the slots 41, flows of fluid are produced parallel to the supporting screen 40 by means of which low-fiber regions form between the slots 41 and the fiber material is bonded above the slots 41.

FIG. 5 shows a sectional view of a further treatment template 10 (sectional view as in FIGS. 2a to 2c) with a strip-like structuring and perforation which can be the same throughout the treatment zone. The treatment template 10 is provided, as has already been shown in FIGS. 2a to 2c, with elevations 12 aligned in the direction of treatment and with valleys 42 between the elevations. The valleys 42 are provided with a first, steeper side wall 43 and a second, less steep side wall 44 which is provided with a step. The fluid jets 13 are directed against the valleys 42 in such way that some extend along the less steeper wall 44 or are reflected by the same over the step, whereas the other fluid jets are guided substantially along the steeper wall 43 to the bottom of the valley. The fluid is sucked off in the bottom of the valley by the treatment template 10. Fluid jets 20 can be disposed so as to be directed against the walls 43 and 44, as is shown in FIG. 5, or they can be distributed in a regular pattern over the width of the template 10.

At the input of the treatment zone the nonwoven 1 rests on the elevations and is then severed into slivers 3 which are driven into the valleys 42. When positioned on the bottom of the valley the slivers 3 are subjected to a twist by the effect of the fluid jets through which the fiber structure is bonded.

FIG. 6 shows in a highly schematic representation of an embodiment of the apparatus in accordance with the invention as an example. Said apparatus is provided with a conveyor belt 40.1 and 40.2 each for supplying the nonwoven 1 and for discharging the slivers 3. The treatment zone 2 is disposed between said conveyor belts. The sliver 1 and the produced slivers 3 are conveyed through the treatment zone by means of the treatment template 10 which is also arranged as a respectively structured conveyor belt. The fluid jets 13 are directed against the treatment template 10. A means 41 for the heat treatment of the slivers may be disposed optionally downstream of the means for producing said jets. Slivers treated with water jets are dried here for example.

The drying of the slivers can also be performed off-line.

The conveyor belt arranged as treatment template 10 can be replaced by a continuous supporting screen which moves over a stationary treatment template, as is shown in FIGS. 4a to 4d.

FIG. 7 shows a further embodiment of the apparatus in accordance with the invention as an example. This apparatus is also shown in a highly schematic way. The nonwoven 1 is produced by a carding machine 50 and supplied directly to the method in accordance with the invention. The apparatus in accordance with the invention is substantially a cylinder-like arrangement 51. The jacket surface of the cylinder rotating in the direction of the arrow is arranged as a treatment template 10 for example. A zone of a second template 30 which is arranged as a continuous belt is guided over rolls 60 in such a way that it is pressed between the rolls against a zone of the first template 10. In order to dose the pressing effect, the rolls can be held in a resilient way. The pressing zone represents the treatment zone 2 which also comprises a means 61 for producing fluid jets 13, namely in such a way that the fluid jets 13 impinge through the second template 30 upon the nonwoven 1 resting on the surface of the cylinder. The means 61 for producing the fluid jets 13 is arranged for example as a hollow beam which is aligned parallel to the cylinder axis, is provided with a wall facing the cylinder surface and comprising nozzles in a respective manner and can be charged with a pressurized liquid.

The cylinder arrangement 51, which is used for the treatment of the nonwoven with fluid-dynamic forces can be installed, as is shown in FIG. 7, at the exit of a conventional carding machine 50 or any other apparatus for producing a nonwoven. It can also be integrated in a carding machine or any other apparatus to produce a nonwoven, i.e. the doffer 62 or any other roller 63 downstream of the doffer 62.

The slivers 3 which are produced in the treatment zone 2 are optionally supplied by the cylinder arrangement 51 to a further treatment station which in the illustrated case comprises a glue bath 52, a sliver storage means 53 and a sliver dryer 54. After the sliver dryer 54, the slivers 3 which are stabilized by the glue treatment are wound up on rolls 55.

If the bonded slivers 3 are subjected to a further treatment by glue, it is advantageous to choose the glue in such a way that it can be removed again from a planar structure which is produced from the slivers 3, which means that it temporarily stabilizes the slivers 3 only for the production of the planar structure.

Further reversible further treatments which are suitable for the bonded slivers are for example known methods such as:

wrapping of the slivers with fibrils made of a thermoplastic material which can be activated in a heat treatment step and can at least partly be removed again from the planar structure by extraction or evaporation;

admixture of bonding fibers which are made of a thermoplastic material to the original staple fiber material, with the thermoplastic material being activated during the fluid treatment (e.g. with saturated steam) or in a further heat treatment step, and can at least partly be removed again from the planar structure by extraction or evaporation;

admixture of a glue to the fluid, which glue can at least partly be removed again from the planar structure by extraction or evaporation;

Polyvinyl alcohol is particularly suitable as a thermoplastic material. It can be activated by heat and is soluble in water, which means that it can easily be washed out from a planar structure.

Further bonding steps which can be used after the conversion of the nonwoven into a plurality of slivers for a further irreversible bonding of the slivers are preferably such methods which work without any addition of foreign material to the original fiber material. These are for example:

false twisting or entangling with air (sliver is guided through a twist or swirl nozzle) or mechanical;

rubbing.

It is understood that the slivers can also be bonded permanently by adding a suitable glue or suitable bonding fibers (e.g. made of polypropylene).

1. A method for producing filamentous textile structures made of a quasi continuous nonwoven (1) in which staple fibers are present in a loose fiber structure, characterized in that the nonwoven (1) is split up longitudinally into a plurality of slivers (3) and the originally loose fiber structure is bonded in such a way that the bonded slivers (3) can be processed into a planar textile structure, with the fiber structure being subjected to fluid-dynamic forces for the longitudinal splitting and/or for at least a part of the bonding of the fiber structure.

2. A method as claimed in claim 1, characterized in that the fiber structure is entangled by the fluid-dynamic forces.

3. A method as claimed in claim 1 or 2, characterized in that the slivers (3) are subjected to twist by the fluid-dynamic forces.

4. A method as claimed in one of the claims 1 to 3, characterized in that fluid jets (13) are directed against the one side of the nonwoven (1) or the slivers (3) for the treatment with fluid-dynamic forces and that the fluid jets (13) penetrate the nonwoven (1) or the slivers (3) and impinge on the other side of the nonwoven (1) upon a first perforated treatment template (10) which is strip-like in the longitudinal direction of the nonwoven and that the fluid is sucked off by said treatment template (10).

5. A method as claimed in claim 4, characterized in that the fluid jets (13) are water, saturated steam or air jets.

6. A method as claimed in one of the claims 4 or 5, characterized in that the fluid jets (13) have a diameter in the range of 0.01 to 1.0 mm.

7. A method as claimed in one of the claims 4 to 6, characterized in that the nonwoven (1) or the slivers (3) are moved through the processing zone (2) resting on the first processing template (10) or on a supporting screen (40) disposed between the fiber material and the first processing template (10).

8. A method as claimed in one of the claims 4 to 7, characterized in that the nonwoven (1) is split up into slivers (3) and the fibers are aligned to a higher extent in the longitudinal direction of the nonwoven in such a way that the fluid jets (13) are directed against unperforated areas in the first treatment template (10).

9. A method as claimed in one of the claims 4 to 8, characterized in that the fiber structure is entangled in the nonwoven (1) and/or in the slivers (3), this being in such a way that it is penetrated by the fluid jets (13) in a needle-like manner.

10. A method as claimed in one of the claims 4 to 7, characterized in that the fiber structure is bonded in the slivers (3) by imparting a twist, such that fluid jets are guided in opposite directions on two sides of the sliver.

11. A method as claimed in one of the claims 1 to 10, characterized in that the nonwoven (1) is a card web or a carded web in which the fibers are preferably aligned in the longitudinal direction of the nonwoven.

12. A method as claimed in one of the claims 1 to 11, characterized in that the slivers (3) are subjected after the treatment with the fluid-dynamic forces to at least one further processing step in which their strength is further increased.

13. A method as claimed in claim 12, characterized in that the slivers (3) are subjected in said additional processing step with a false twist, that the fiber structure is entangled or the slivers (3) are rubbed.

14. A method as claimed in claim 12, characterized in that the slivers (3) are treated in said additional processing step with a glue.

15. A method as claimed in claim 14, characterized in that the glue is contained in the fluid of the fluid jets (13).

16. A method as claimed in claim 12, characterized in that bonding fibers are admixed to the staple fiber material or the slivers (3) are wrapped around with filaments, which bonding fibers or filaments consist of a thermoplastic material, and that said thermoplastic material is activated during the treatment with fluid-dynamic forces or in a further heat treatment.

17. A method as claimed in one of the claims 14 to 16, characterized in that the glue or the thermoplastic material is soluble or can be evaporated in such a way that it can be removed at least partly by extraction or evaporation from a planar structure comprising the sliver (3).

18. A method as claimed in claim 17, characterized in that the thermoplastic material is polyvinyl alcohol.

19. The use of a sliver (3) produced according to the method as claimed in one of the claims 1 to 18 for producing planar structures according to methods which are known per se.

20. The use of a sliver (3) produced according to the method as claimed in one of the claims 1 to 18 for producing planar structures which comprise further filamentous structures in addition to the sliver (3).

21. The use of a sliver (3) produced according to the method as claimed in one of the claims 1 to 18 for producing planar structures by weaving.

22. The use of a sliver (3) produced according to the method as claimed in one of the claims 1 to 18 as a weft yarn in a fabric.

23. The use of a sliver (3) produced according to the method as claimed in one of the claims 1 to 18 for producing fabrics for disposable linens.

24. An apparatus for producing filamentous structures made of a nonwoven (1) which consists of a staple fiber material and in which the fibers are present in a loose fiber structure, characterized by means for supplying the nonwoven (1) in a feeding direction (F), means for the longitudinal severing of the nonwoven (1) into a plurality of slivers, means for bonding the fiber structure in the nonwoven (1) and/or in the slivers (3), namely in such a way that the bonded slivers are suitable for producing planar structures, and means for discharging the bonded slivers (3) in a discharging direction (F′), with the means for longitudinal severing and/or the means for bonding comprising means for treating the nonwoven (1) and/or the slivers (3) with fluid-dynamic forces.

25. An apparatus as claimed in claim 24, characterized in that the means for treatment comprises a strip-like perforated first treatment template (10) on which the nonwoven (1) can be positioned and means for producing fluid jets (13) directed against the nonwoven (1) positioned on the first treatment template (10).

26. An apparatus as claimed in claim 25, characterized in that the first treatment template (10) can be moved in a direction combining the feeding direction (F) and the discharging direction (F′) and that the nonwoven (1) can be placed against the first treatment template (10).

27. An apparatus as claimed in claim 25, characterized in that the first treatment template (10) is substantially stationary and that a supporting screen (40) is provided which can be moved over the first treatment template (10) in a direction combining the feeding direction (Z) and the discharging direction (Z′) and can be placed against the nonwoven (1).

28. An apparatus as claimed in one of the claims 25 to 27, characterized in that the first treatment template (10) is provided with a pattern of perforations or slots (41).

29. An apparatus as claimed in claim 25 to 28, characterized in that the first treatment template (10) is provided with elevations and valleys extending between said elevations, and that the perforations or slots (41) are disposed in the valleys.

30. An apparatus as claimed in claim 29, characterized in that the tillers (42) of the treatment template (10) are provided with a first, steeper wall (43) and a second, less steep wall (44) which is provided with a step.

31. An apparatus as claimed in one of the claims 25 to 30, characterized in that the treatment template (10) or the supporting screen (40) is arranged as a revolving belt or as a jacket of a rotating cylinder.

32. An apparatus as claimed in one of the claims 25 to 31, characterized in that a means (61) for producing fluid jets (13) comprises a plurality of nozzles (20) which are arranged in a pattern adjusted to the perforation of the first treatment template (10) and that the nozzles (20) have a diameter in the range of 0.01 to 1.0 mm.

33. An apparatus as claimed in one of the claims 24 to 32, characterized in that the means for bonding the fiber structure comprise means for a heat treatment of the slivers (3), means for treatment with glue of the slivers (3), means for providing a false twist to the slivers (3) and/or means for rubbing the slivers (3).
